(19) United States
(12) Patent Application Publication
(10) Pub. No.: US 2022/0200379 A1
(43) Pub. Date: Jun. 23, 2022

(54) INJECTION-MOLDED MAGNET HOLDER FOR A BRUSHLESS ELECTRIC MOTOR

(71) Applicant: Nidec Corporation, Kyoto (JP)

(72) Inventor: Pascual GUARDIOLA, Ingersheim (DE)

(21) Appl. No.: 17/259,799

(22) PCT Filed: Jul. 12, 2019
(86) PCT No.: PCT/IB2019/055946

§ 371 Date: Jul. 28, 2021

(30) Foreign Application Priority Data
Jul. 13, 2018 (DE) 102018116986.8
Jul. 10, 2019 (DE) 102019118646.3

(51) Int. Cl. H02K 1/278; H02K 1/276; H02K 15/03; H02K 1/30

(52) U.S. Cl. CPC H02K 1/278; H02K 1/30; H02K 15/03; H02K 1/2773

(57) ABSTRACT

A rotor assembly includes an annular rotor core surrounding a central axis, magnet arrangements arranged around the rotor core in a circumferential direction of the rotor assembly, each magnet assembly including a convex outer peripheral surface, an inner contact surface, two axial end surfaces and two side surfaces pointing in the radial direction, a magnet holder integrally injection-moulded on the rotor core and including holding sections uniformly spaced in the circumferential direction, each between two adjacent magnet arrangements. The holding sections each include a shaft section and a head section, the shaft section being located circumferentially between the magnet arrangements and the head section being at one end of the shaft section.

### CROSS REFERENCE TO RELATED APPLICATIONS

This is a U.S. national stage of PCT Application No. PCT/IB2019/055946, filed on Jul. 12, 2019, with priority under 35 U.S.C. § 119(a) and 35 U.S.C. § 365(b) being claimed from German Application No. 102018116986.8, filed Jul. 13, 2018 and German Application No. 102019118646.3, filed on Jul. 10, 2019; the entire disclosures of which applications are hereby incorporated herein by reference.

### FIELD OF THE INVENTION

The present invention relates to a rotor assembly of a brushless electric motor, a brushless electric motor, and a method of manufacturing a magnet holder.

### BACKGROUND

Prior art electric motors are known in which the rotor carries a permanent magnet. The permanent magnets are arranged around a rotor core and sit on its outside. The rotor defines the geometrical axes and directions, which are also to be used in this description and the patent claims. A central axis coincides with the axis of symmetry of the rotor and also represents the axis of rotation of the rotor in the electric motor. The axial direction of the arrangement is in the direction of the axis of rotation. The radial direction is characterized by increasing distance from the central axis. The permanent magnets of the rotor are therefore located on the outside in the radial direction. Tangential to the rotor is the circumferential direction, where each directional vector is perpendicular to a radius of the arrangement.

According to the state of the art, the electric motor also has a stator arranged radially outside the rotor, which surrounds the rotor on the outside in a ring shape. The stator contains a number of electromagnets, which are generally formed by an iron core and a winding. An appropriate current flow through the stator's windings generates a rotating field, which in turn generates a torque in the rotor. The stator is located in a motor housing in which the rotor with its motor shaft is rotatably mounted.

The permanent magnets are usually made of a brittle material. The magnets are not screwed to the rotor core, but sit on outwardly facing flat surfaces of the rotor core, where they are mechanically held by a magnet holder. The magnet holder absorbs in particular the centrifugal forces that act on the magnets during the rotation of the rotor.

The magnetic holders therefore have the task of holding the magnets firmly and precisely in the intended position. On the other hand they also serve as guides. During production, the rotor core is first fitted with the magnet holder and the magnets are then pushed into the intended positions, whereby they are pushed in an axial direction along the flat outer surface of the rotor core between two holding sections of the magnet holder. Such magnet holders are known from state-of-the-art technology, for example from U.S. Pat. No. 7,687,957 B2 and US 2015/0001978.

Traditionally, the magnetic holders are manufactured as a separate component. However, it is also known that the magnetic holders are injection molded onto the rotor core.

### SUMMARY

Example preferred embodiments of the present disclosure provide rotor assemblies each with a magnet holder and electric motors in each of which the magnet holder is particularly easily and inexpensively able to be manufactured.

A rotor assembly according to an example preferred embodiment of the present invention includes an annular rotor core surrounding a central axis, a plurality of magnet arrangements arranged around the rotor core in a circumferential direction of the rotor assembly and each including a convex outer peripheral surface, an inner contact surface, two axial end surfaces and two circumferentially opposing side surfaces, a magnet holder injection moulded onto the rotor core, which includes a number of holding sections evenly spaced in the circumferential direction, each of which is between two adjacent magnet arrangements, the holding sections each including a shank section and a head section, the shank section being located circumferentially between the magnet arrangements and the head section being provided at one end of the shank section, the head section projecting radially inwardly beyond the shank section towards the rotor core and engaging a corresponding recess of the rotor core located in the region of the end surface of the rotor core to secure the magnet holder to the rotor core in the radial direction.

The magnetic holder is preferably one-piece and completely injection molded. Preferably, only the head section fixes the magnets to the rotor core. This has the advantage that less material is needed. In addition, the matching rotor core has a simple design that can be produced by cold extrusion and is therefore particularly easy to manufacture.

Preferably, the head section has a height in the direction of the central axis that does not exceed 20%, in particular 10%, of the total height of the rotor assembly, for example. This allows material to be saved and the shape of the rotor core to be significantly simplified. Only in this way can the rotor core be manufactured by cold extrusion.

In a preferred embodiment, the head section is T-shaped in a cross section along a plane transverse to the central axis and engages with its undercuts in the radial direction in the corresponding recess of the rotor core during injection. In this way, the magnetic holder is positively connected to the rotor core.

Preferably, the shaft sections are T-shaped in a cross section along a plane transverse to the central axis, so that the shaft sections fix the position of the magnet arrangements in radial direction to the rotor core. The shaft sections thus define a seat of the magnet arrangements and cover them at least partially on the outside so that their position in the radial direction is defined.

Preferably the shaft sections each include a web which is inserted into a groove extending on the outside of the rotor core, in the direction of the central axis. The web and the groove preferably extend from the head section or recess over the remaining height of the rotor core and can thus ensure in interaction that the position of the magnet holder on the rotor core is defined in the circumferential direction over the entire height of the magnet arrangement.

It is advantageous if the web is rectangular or substantially rectangular in a cross-section along a plane transverse to the central axis. The corresponding groove can be easily provided on the rotor core.

Preferably, the holding sections are molded onto a base of the magnet holder. In one example preferred embodiment, the holding sections can include holding arms which are spaced from each other in the circumferential direction. However, it can also be provided that the magnet holder surrounds the magnet arrangements in the circumferential direction without interruption and over the total height of the magnet holder. In this case, the magnet holder is preferably pot-shaped and includes a jacket on a base, with the holding sections on the inside of the jacket.

In an example preferred embodiment, the magnet arrangements are each provided by a permanent magnet, which in each case includes a planar outer contact surface, a planar inner contact surface, two axial end surfaces and two side surfaces, and by a magnetic flux conductor, which includes a convex outer circumferential surface and a planar inner contact surface, the planar inner contact surface of the respective magnetic flux conductor being in contact with the planar outer contact surface of the corresponding permanent magnet, and the magnetic flux conductor in each case being formed in one piece.

Preferably, the rotor core includes flat outer surfaces on the outside, each of the same size and shape, distributed at uniform angular intervals along the outer peripheral surface of the rotor core, with the groove provided between each two outer surfaces, which extends from the outside in the radial direction into the edge defined by the two adjacent outer surfaces in this area.

The magnetic holder is preferably made of polybutylene terephthalate with glass fiber or polyamide.

Furthermore, a brushless electric motor with a stator, a motor shaft rotatably mounted in a housing, and with an internal rotor assembly mounted on the motor shaft as described above is provided. In this case the stator surrounds the rotor on the outside.

An example preferred embodiment of a process for manufacturing a magnetic holder for an internal rotor assembly of a brushless electric motor according to the present invention includes providing an injection mold, placing a rotor core in the injection mold, inserting magnet arrangement placeholders of the rotor assembly, inserting a plastic into the injection mold, removing the cast product and removing the placeholders.

However, the manufacturing process may also involve placing the rotor core and magnet arrangements in the injection mold and overmolding them. The magnet holder is preferably a one-piece, injection-molded structure.

It is preferable to include recesses used to inject the plastic at one end of the rotor core in the direction of a central axis. Only the head section of the magnet holder defined by the recesses in the injection molding process fixes the magnets to the rotor core. This has the advantage that less material is required. In addition, the matching rotor core has a simple design that can be produced by cold extrusion and is therefore particularly easy to manufacture.

The recesses are preferably T-shaped in the radial direction and open at the top, in the direction of the central axis. It is advantageous if the recesses have a constant depth in the direction of a central axis. Preferably, the recess and thus the head section formed in the injection molding process has a height in the direction of the center axis which corresponds to a maximum of 20%, in particular a maximum of 10%, of the height of the rotor core. This saves material of the magnetic holder and simplifies the shape of the rotor core considerably, as the recesses are only located at the front side and do not extend in the form of webs over the entire height of the core.

Preferably, the injection mold has a negative imprint to define spaced holding arms in the circumferential direction around the rotor core such that the holding arms are injection molded onto the rotor core and connect to it with a positive fit.

However, it may also be provided that the injection mold has a negative imprint to define a pot-shaped magnet holder such that holding arms are formed on the inside of the magnet holder in the circumferential direction around the rotor core, which are injection molded onto the rotor core and connect with it in a form-fit manner.

It is generally advantageous if the plastic is polybutylene terephthalate with 30% glass fiber (PBT 30) or polyamide (PA).

The above and other elements, features, steps, characteristics and advantages of the present disclosure will become more apparent from the following detailed description of the example embodiments with reference to the attached drawings.

### BRIEF DESCRIPTION OF THE DRAWINGS

Example preferred embodiments of the present disclosure are described in more detail below with reference to the drawings. Identical components or components with identical functions bear identical reference signs.

FIG. 1 illustrates a rotor assembly according to a preferred embodiment of the present invention in a perspective view with a magnetic holder.

FIG. 2 is a perspective view of a rotor core according to a preferred embodiment of the present invention.

FIG. 3 is a perspective view of the magnet holder.

FIG. 4 is an electric motor with the rotor assembly of FIG. 1.

### DETAILED DESCRIPTION

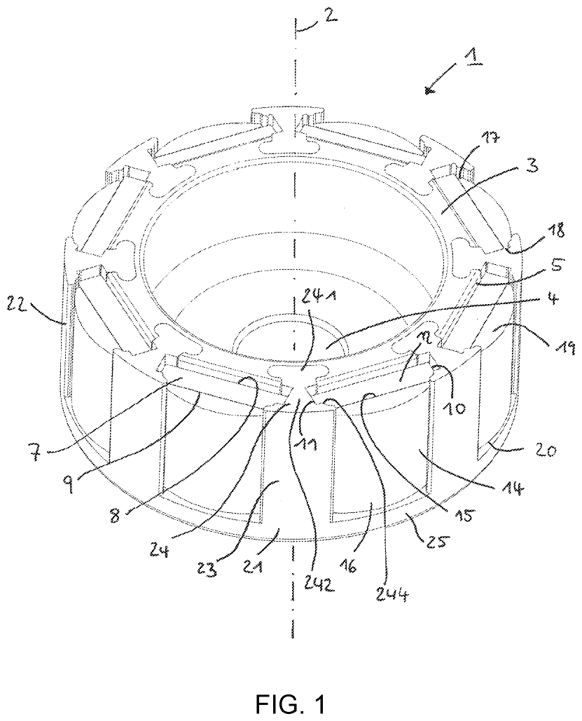

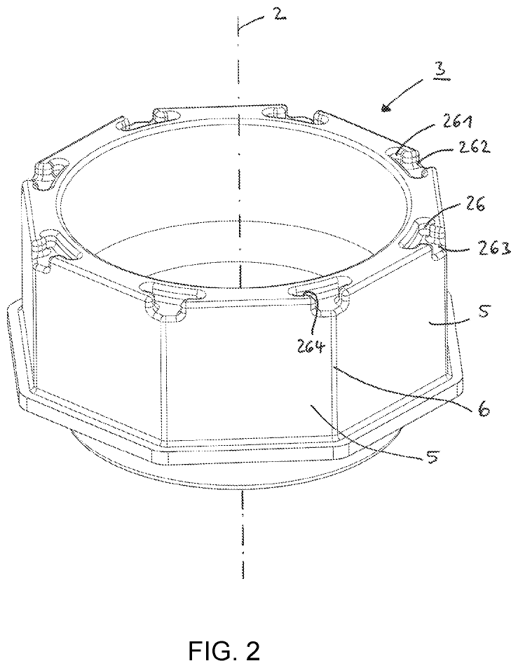

FIG. 1 shows a rotor assembly 1 with a central axis 2, which coincides with an intended axis of rotation of the rotor assembly 1. The rotor assembly 1 includes an essentially rotationally symmetrical rotor core 3, which has a central bore 4 to accommodate a motor shaft not shown. The rotor core is an internal rotor core and part of a brushless electric motor designed as an internal rotor motor. FIG. 2 shows the rotor core in detail. On its outside, the rotor core has 3 flat outer surfaces 5. In this design example, a total of eight outer surfaces 5, each of the same size and shape, are distributed at equal angular intervals along the outer circumferential surface of the rotor core 3. The rotor core 3 is manufactured in one piece. It therefore does not consist of several lamellas lying on top of each other, or it is not a layered core. It is formed from one workpiece. It is preferably made of a soft steel with a high iron content and is preferably produced by cold pressing. A groove 6 is provided between each two outer surfaces 5, which is formed from the outside in the radial direction into the edge formed by the two adjacent outer surfaces 5 in this area. The groove 6 is open radially outwards and runs parallel to the central axis 2. At one end of the rotor core 3 in the axial direction, recesses 26 are arranged. The recesses 26 extend in a T-shape, generally in the radial direction, with the transverse portion of the recess 261 oriented in the circumferential direction and the portion 262 perpendicular to it extending radially outwards from the transverse portion 261. The recess 26 is thus open at the top, in the axial direction, and open on one side in the radial direction, the opening 263 in the radial direction having a clear width which is smaller than the width of the recess 26 in the circumferential direction. The recess 26 thus has an undercut 264 in the radial direction. In axial direction, recess 26 has a constant depth and no undercuts. The depth is preferably in a range between 0.5 mm and 1.5 mm, especially a maximum of 2 mm in axial direction. Due to the simplicity of the recess 26, it can be formed when forming the rotor core 3. Therefore, no reworking is required to form the recesses 26, which greatly simplifies the production of the rotor core 3 and reduces costs. In the circumferential direction, the recesses 26 are located in the area of the edges between two adjacent outer surfaces 5. From one recess 26 at one end of the rotor core to the other end of the rotor core, a groove 6 extends in the axial direction along the edges between two adjacent outer surfaces 5. The grooves 6 are also formed during the shaping of the rotor core 3 and do not require any reworking.

As shown in FIG. 1, a total of eight cuboid permanent magnets 7 are attached to the outer surfaces 5 of the rotor core 3, which have a rectangular cross-section with an inner flat contact surface 8, an outer flat contact surface 9, and two flat side surfaces 10,11. The inner contact surface 8 of the permanent magnets 7 points radially inwards towards the rotor core 3 and the outer contact surface 9 is opposite the inner contact surface and points radially outwards away from the rotor core 3. The side surfaces 10,11 extend in radial direction, perpendicular to the contact faces 8,9. Finally the permanent magnets 7 have axial end surfaces 12. The permanent magnets 7 are preferably made of neodymium or ferrite and are preferably manufactured in a sintering process.

At the outer contact surfaces 9 of the permanent magnets there are magnetic flux conductors 14, each of the same size and shape, distributed at uniform angular intervals along the outer peripheral surface of the rotor core 3. The magnetic flux conductors 14 each have a flat contact surface 15, a convex outer circumferential surface 16 and side surfaces 17,18. The flat contact surface 15 of the magnetic flux conductors points radially inwards towards the rotor core 3 and the convex outer circumferential surface 16 points radially outwards away from the rotor core 3. The side surfaces 17,18 of the magnetic flux conductors extend approximately in radial direction and are opposite each other in circumferential direction. Finally, the magnetic flux conductors 14 still have axial end surfaces 19,20. The magnetic flux conductors 14 lie with their flat contact surface 15 in contact with the outer contact surface 9 of the permanent magnets and extend over a range of at least 80% of the width of the outer contact surface in the circumferential direction. In axial direction the permanent magnets and the magnetic flux conductors preferably have the same length. The radius of convexity of the outer circumferential surface 16 of the magnetic flux conductor 14 is smaller than or equal to the radius of the envelope of the rotor core, in particular at least half the radius of the envelope. The magnetic flux conductors 14 are preferably made of a soft steel with a high iron content. The magnetic flux conductors 14 are preferably made in one piece, i.e. they do not consist of several lamellas lying on top of each other. They are preferably made from one workpiece, in particular in an extrusion process, and are cut to their length extending in the axial direction. The side surfaces 17,18 of the magnetic flux conductors 14 are formed by deburring the edges. The magnetic flux conductors 14 are designed to influence the magnetic fluxes generated by the permanent magnets 7. Due to the convexity of the magnetic flux conductors 14, the magnetic flux is focused in such a way that a limited area with higher flux density is formed radially outwards, away from the rotor core 3.

The permanent magnets 7 and magnetic flux conductors 14 are held on the rotor core 3 via a magnet holder 21. The magnet holder 21 is made of an injection-moldable plastic, preferably polybutylene terephthalate with 30% glass fiber (PBT 30) or polyamide (PA), and is preferably produced in an injection molding process. The magnetic holder 21 has holding sections 22, each of which has a shaft section 23 and a head section 24, whereby the shaft section 23 extends into the groove 7 by means of a web and is held there with a positive fit. The cross section of the web has no undercuts and is preferably essentially rectangular in cross-section. The shaft sections 23 of the holding sections 22 extend vertically from a ring-shaped base 25 of the magnet holder 21. The holding sections 22 are formed on the outside of the base 25. The base 25 is dimensioned in such a way that the rotor core 3, the permanent magnets 7 and the magnetic flux conductors 14 rest with their one end surface at least partially on the base. The head section 24 is molded onto the side of the shaft section 23 remote from the floor and extends in the radial direction of the arrangement, away from the shaft section 23, towards the rotor core 3. The permanent magnets 7 and the magnetic flux conductors 14 are fixed by the holding sections 22 in the circumferential direction of the rotor assembly 1 by resting with their side surfaces against the respective adjacent shaft section 23. In radial direction outwards, the permanent magnets 7 and the magnetic flux conductors 14 are also held by the shaft sections. The shaft sections 23 have a seat for the permanent magnets 7 and a seat for the magnetic flux conductors 14. For this purpose, the shaft sections 23 are essentially T-shaped in cross-section, with the part extending in the radial direction forming the web engaging in the groove 6 and the part extending in the circumferential direction holding the magnetic flux conductors 14 and the permanent magnets 7 in position in the radial direction.

The head section 24 is T-shaped at its end close to the rotor core, with the transverse area of the head section 241 being oriented in the circumferential direction and the area 242 perpendicular to it extending radially outwards from the transverse area 241. The head section 24 thus has an undercut 244 in the radial direction. In axial direction the head section 24 has a constant height and no undercuts. The head section 24 engages in the corresponding recess 26 of the rotor core 3, which is located in the area of the front face of the rotor core 3 and thus forms a fixation of the magnet holder 21 in relation to the rotor core 3 in the axial direction with the help of the bottom 25 of the magnet holder 21. The height of the head section 24 corresponds approximately to the depth of the recess 26 of the rotor core 3. The head section 24 engages in the radial direction in the undercuts of the recess and fixes the magnet holder 21 to the rotor core 3 in the radial direction.

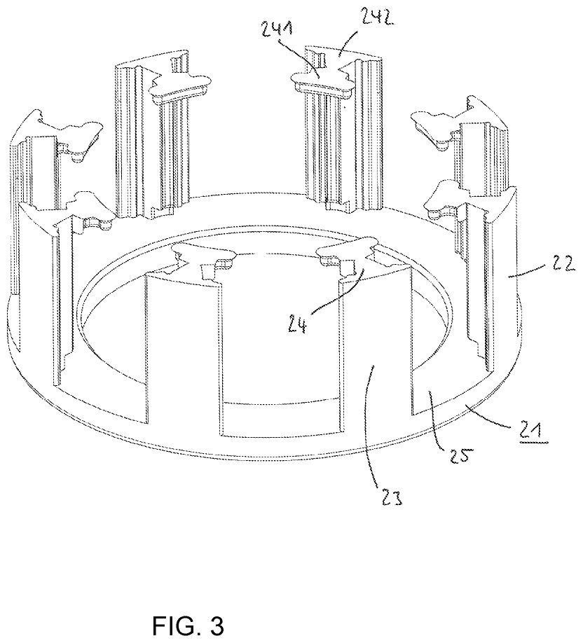

FIG. 3 shows the individual magnetic holder 21. The magnetic holder 21 is molded onto the rotor core 3. For this purpose, the rotor core 3 is placed in a corresponding injection mold, which provides space for the permanent magnets and magnetic flux conductors. The magnetic holder 21 shown in FIG. 3 has holding arms arranged in a circumferential direction, which form the holding sections 22. It can also be provided that the rotor core 3 is completely overmolded in the circumferential direction. In this case, the magnet holder is essentially pot-shaped, with the holding sections starting from the inside of the shell.

After the magnet holder 21 has been molded onto the rotor core, the permanent magnets 7 are pushed into the magnet holder 21 towards the floor 25. The shaft sections 23 of the magnet holder serve as a guide and the base 25 as a stop in the axial direction. After the permanent magnets 7 have been inserted, the magnetic flux conductors 21 are inserted in the same direction, here too the shaft sections 23 serve as a guide and the base 25 as a stop. Finally, a sleeve not shown is pushed onto the rotor assembly in the direction towards the floor, covering the end surfaces of the elements 7,14,3 on the side facing away from the floor, thus fixing the position of the permanent magnets 7 and the magnetic flux conductors 14 in the axial direction with the help of the base 25, relative to the magnet holder 21.

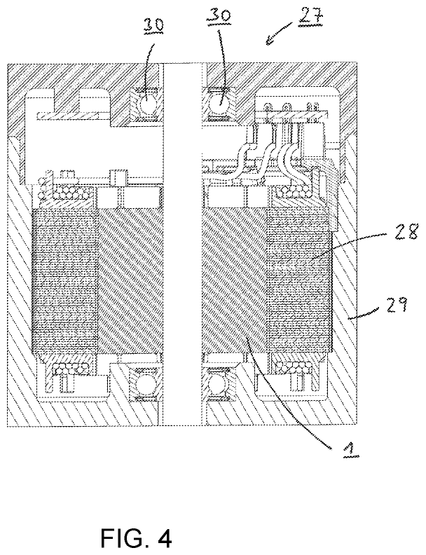

FIG. 4 shows a cross-sectional view of an electric motor 27 with rotor core 3. The electric motor 27 comprises stator 28. Inside stator 28, rotor assembly 1 with rotor core 3 is rotatably mounted in a manner known per se. The arrangement is surrounded by a motor housing 29, which carries roller bearings 30 for the rotatable mounting of rotor assembly 1.

While example preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-20. (canceled)

21. A rotor assembly of a brushless electric motor, the rotor assembly comprising:
an annular rotor core surrounding a central axis;
magnet arrangements positioned around the rotor core in a circumferential direction of the rotor assembly, and which each include a convex outer circumferential surface, an inner abutting surface, two axial end surfaces, and two side surfaces pointing in a radial direction;
a magnet holder integrally injection-molded onto the rotor core and including a number of circumferentially uniformly spaced holding sections each between two adjacent magnet arrangements; wherein
the holding sections each include a shaft section and a head section, the shaft section being located circumferentially between the magnet arrangements and the head section being provided at one end of the shaft section;
the head section projects beyond the shaft section in the radial direction, inwardly towards the rotor core, and engages in a corresponding recess of the rotor core in a region of the end surface of the rotor core such that the magnet holder is secured to the rotor core in the radial direction.

22. The rotor assembly according to claim 21, wherein the head section has a height in extending in a direction along the central axis which is at most 20% of a total height of the rotor assembly.

23. The rotor assembly according to claim 22, wherein the head section has a height in the direction along the central axis which is at most 10% of the total height of the rotor assembly.

24. The rotor assembly according to claim 21, wherein
the head section has a T-shape in a cross-section along a plane extending transversely to the central axis and engages with a corresponding recess of the rotor core through undercuts in the radial direction.

25. The rotor assembly according to claim 21, wherein
the shaft sections are T-shaped in a cross section along a plane transverse to the central axis, such that the shaft sections fix the magnet arrangements to the rotor core in a radial direction of the rotor core.

26. The rotor assembly according to claim 21, wherein
the shaft sections each include a web which is inserted into a groove extending on an outside of the rotor core in a direction along the central axis.

27. The rotor assembly according to claim 26, wherein the web is rectangular or substantially rectangular in cross-section along a plane transverse to the central axis.

28. The rotor assembly according to claim 21, wherein the holding sections are on a bottom of the magnet holder.

29. The rotor assembly according to claim 21, wherein the holding sections include holding arms which are spaced apart from each other in the circumferential direction.

30. The rotor assembly according to claim 21, wherein the magnet holder surrounds the magnet arrangements in the circumferential direction without interruption and over an entire height of the magnet holder.

31. The rotor assembly according to claim 30, wherein the magnet holder is pot-shaped and includes a casing on a base, the holding sections being on an inside of the shell.

32. The rotor assembly according to claim 21, wherein
the magnet arrangements each include:
a permanent magnet which includes a plane outer bearing surface, a plane inner bearing surface, two axial end surfaces and two side surfaces; and
a magnetic flux conductor with a convex outer circumferential surface and a planar inner contact surface; and
the planar inner contact surface of respective ones of the magnetic flux conductors are in contact with the planar outer contact surface of corresponding ones of the permanent magnets, the magnetic flux conductor being defined by a single piece structure.

33. The rotor assembly according to claim 21, wherein
the rotor core includes flat outer surfaces on an outside, each of the flat outer surfaces having a same size and shape and being distributed at uniform angular intervals along the outer circumferential surface of the rotor core; and
between each pair of the outer surfaces a groove is provided from the outside in the radial direction in an edge defined by the pair of outer surfaces.

34. A brushless electric motor comprising a stator, a motor shaft rotatably mounted in a housing, and the rotor assembly mounted on the motor shaft according to claim 21.

35. A method of manufacturing a magnetic holder of an internal rotor assembly of a brushless electric motor, the method comprising:
providing an injection mould;
placing a rotor core in the injection mould;
inserting magnet arrangement placeholders of the rotor assembly;
inserting a plastic into the injection mould; and
removing a cast product and the magnet arrangement placeholders.

36. A method of manufacturing a magnetic holder of an internal rotor assembly of a brushless electric motor, the method comprising:
providing an injection mould;
placing a rotor core in the injection mould;
inserting magnet arrangement placeholders of the rotor assembly;
inserting a plastic material into the injection mould and encapsulating the rotor core and magnet arrangements; and
removing a cast product and removing the magnet arrangement placeholders.

37. The method according to claim 35, wherein recesses used in the inserting of the plastic material are positioned at one end of the rotor core in a direction of a central axis.

38. The method according to claim 37, wherein the recesses are T-shaped in a radial direction and are open towards a top, in an axial direction.

39. The method according to claim 37, wherein the recesses have a constant depth in a direction of a central axis, which corresponds to at most 20% of a total height of the rotor core.

40. The method according to claim 35, wherein the injection mould includes a negative imprint that forms spaced-apart holding arms in the circumferential direction around the rotor core, the holding arms being injection moulded onto the rotor core and the magnet arrangements and being connected to the rotor core in a fixed manner.
